(19) United States
(12) Patent Application Publication
(10) Pub. No.: US 2023/0349362 A1
(43) Pub. Date: Nov. 2, 2023

(54) WIND POWER GENERATION DEVICE

(71) Applicant: TOYOTA JIDOSHA KABUSHIKI KAISHA, Aichi-ken (JP)

(72) Inventor: Kunihiro KOBAYASHI, Toyota-shi (JP)

(21) Appl. No.: 18/174,653

(22) Filed: Feb. 27, 2023

(30) Foreign Application Priority Data
May 2, 2022 (JP) 2022-076179

(51) Int. Cl. F03D 15/00; H02P 9/06

(52) U.S. Cl. CPC F03D 15/00; H02P 9/06; F05B 2260/964; F05B 2260/4023; F05B 2270/32; H02P 2101/15

(57) ABSTRACT

The wind power generation device includes a blade, a power distribution unit, a first generator, a second generator, a clutch unit, and a control unit. The control unit controls connection and disconnection of the clutch unit such that the clutch unit is disconnected when the wind speed input to the blade is smaller than a predetermined first wind speed value and the clutch unit is connected when the wind speed input to the blade is larger than a predetermined second wind speed value.

### CROSS-REFERENCE TO RELATED APPLICATION

This application claims priority to Japanese Patent Application No. 2022-076179 filed on May 2, 2022, incorporated herein by reference in its entirety.

### BACKGROUND

### 1. Technical Field

A technique disclosed in the present specification relates to a wind power generation device.

### 2. Description of Related Art

Japanese Unexamined Patent Application Publication No. 2003-336571 (JP 2003-336571 A) discloses a wind power generation device that distributes power output from a wind turbine and inputs the power to a plurality of generators. An input shaft of each of the generators is provided with a clutch that can be connected and disconnected.

### SUMMARY

The technique of JP 2003-336571 A does not disclose specific conditions and control contents for connecting and disconnecting a clutch. In the present specification, clutch control capable of increasing power generation efficiency in a wind power generation device including a plurality of generators is proposed.

A wind power generation device according to a first aspect of the present disclosure includes:
a blade;
a power distribution unit for distributing power output from the blade;
a first generator to which the power distributed by the power distribution unit is input;
a second generator of which starting torque is larger than starting torque of the first generator and to which the power distributed by the power distribution unit is input;
a clutch unit provided on a power transmission path between the power distribution unit and the second generator; and
a control unit configured to control connection and disconnection of the clutch unit so as to disconnect the clutch unit when a wind speed input to the blade is smaller than a predetermined first wind speed value and connect the clutch unit when the wind speed input to the blade is larger than a predetermined second wind speed value.

According to such a configuration, when the wind speed is smaller than the first wind speed value, it is possible to generate electric power using only the first generator having the small starting torque. Since a cut-in wind speed can be shifted to the low wind speed side, the power generation amount can be increased. Further, when the wind speed is greater than the second wind speed value, both the first generator and the second generator can be used to generate electric power. Since the rated output can be increased, the power generation efficiency can be increased. The first wind speed value and the second wind speed value may be the same value.

In the wind power generation device according to the first aspect, the second wind speed value may be larger than the first wind speed value.

According to such a configuration, hysteresis can be imparted by increasing the second wind speed value for connection of the clutch unit as compared with the first wind speed value for disconnection of the clutch unit. An undesired transition of the connection state of the clutch unit due to a minute fluctuation of the wind speed can be suppressed.

The wind power generation device according to the first aspect may further include:
an input shaft for connecting the blade and the power distribution unit;
a first output shaft for connecting the power distribution unit and the first generator; and
a second output shaft for connecting the power distribution unit and the second generator. Here, the number of rotations of the first output shaft per rotation of the input shaft may be less than the number of rotations of the second output shaft per rotation of the input shaft. According to such a configuration, the speed can be increased by the power distribution unit such that the number of rotations of the first output shaft is less than the number of rotations of the second output shaft. Since the torque inversely proportional to the speed increase of the rotation can be obtained, the first output shaft can output higher torque than the second output shaft. Since the cut-in wind speed of the first generator can be shifted to the low wind speed side, the power generation amount can be increased.

The wind power generation device according to the first aspect may further include a damper that is provided on the first output shaft and that has torsional elasticity against a torsional force input to the first output shaft.

According to such a configuration, impact torque toward the first generator can be damped due to torsional elastic deformation of the damper. It is possible to suppress the large impact torque from acting on the first generator.

The wind power generation device according to the first aspect may further include a torque limiter that is provided on the first output shaft and that maintains transmission torque of the first output shaft within upper limit torque.

According to such a configuration, even when excessive torque is continuously input, it is possible to suppress transmission of the excessive torque to the first generator. It is possible to suppress mechanical stress from being applied to the first generator.

The wind power generation device according to the first aspect may further include a flywheel provided on the first output shaft.

According to such a configuration, the moment of inertia of a rotary system can be increased. This enables the rotational speed of the first output shaft to be slowly changed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a wind power generation device 1;

FIG. 2 is a diagram illustrating an example of a power curve of the wind power generation device 1; and

FIG. 3 is a diagram illustrating an example of clutch engagement control by the clutch control unit 40.

### DETAILED DESCRIPTION OF EMBODIMENTS

### First Embodiment

Configuration of the Wind Power Generation Device 1

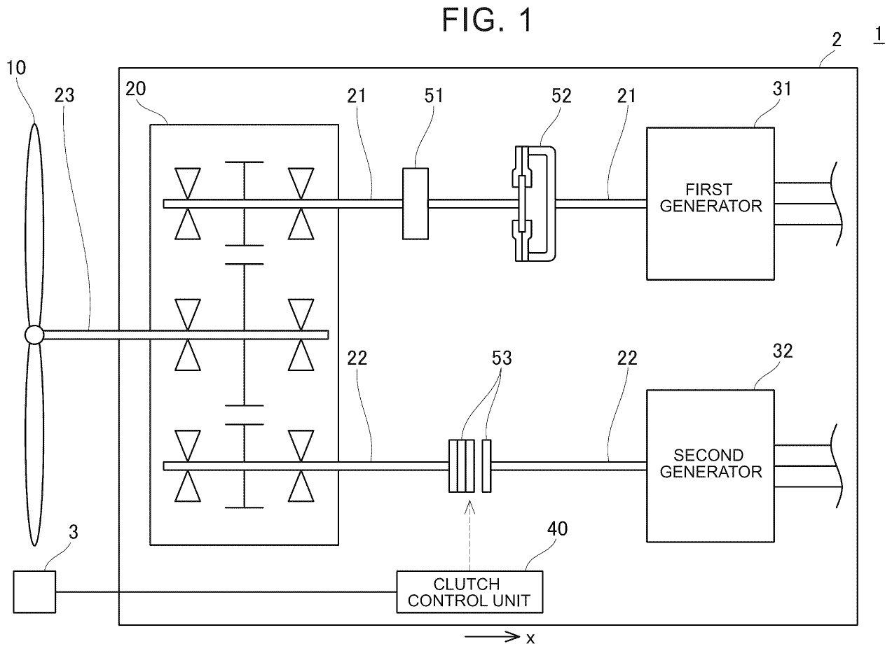

FIG. 1 is a schematic configuration diagram of a wind power generation device 1. The wind power generation device 1 includes a nacelle 2, an anemometer 3, and a blade 10. The nacelle 2 mainly includes a speed increaser 20, a first generator 31, a second generator 32, a clutch control unit 40, a flywheel 51, a torque limiter 52, and a clutch unit 53. The anemometer 3 is a sensor that measures the wind speed of the wind input to the blade 10. In FIG. 1, the ratio of the sizes of the constituent elements is different from the actual ratio.

The speed increaser 20 functions as a power distribution unit that distributes the power output from the blade 10. Since the structure of the speed increaser 20 is known, a description thereof will be omitted. The input shaft 23 connects the blade 10 and the speed increaser 20. The first output shaft 21 connects the speed increaser 20 and the first generator 31. The first output shaft 21 is a power transmission path between the speed increaser 20 and the first generator 31. The second output shaft 22 connects the speed increaser 20 and the second generator 32. The second output shaft 22 is a power transmission path between the speed increaser 20 and the second generator 32.

The speed increaser 20 increases the rotational driving force input to the input shaft 23 in accordance with the speed increasing ratio and outputs the rotational driving force to the first output shaft 21 and the second output shaft 22. The number of revolutions of the first output shaft 21 per one rotation of the input shaft 23 is smaller than the number of revolutions of the second output shaft 22 per one rotation of the input shaft 23 In other words, the speed transmission ratio (=number of rotations of the drive shaft/number of rotations of the driven shaft) of the first output shaft 21 is larger than that of the second output shaft 22. Since the torque inversely proportional to the speed increase of the rotation can be obtained, the first output shaft 21 can output a higher torque than the second output shaft 22.

The first output shaft 21 is provided with a flywheel 51 and a torque limiter 52. The flywheel 51 is a mechanism capable of increasing the moment of inertia of the rotation system of the first output shaft 21. Thus, the change in the rotational speed of the first output shaft 21 can be made gentle. By stabilizing the rotation speed fluctuation due to the unstable wind speed fluctuation by inertia, stable power generation by the first generator 31 is possible. Since the structure of the flywheel 51 is known, a description thereof will be omitted.

The torque limiter 52 is a mechanism capable of limiting the transmission torque so as not to exceed the torque upper limit value when a torque larger than a predetermined torque upper limit value is input. The torque upper limit value can be determined in advance based on the performance of the first generator 31 or the like. Since the structure of the torque limiter 52 is known, a description thereof will be omitted. By providing the torque limiter 52, it is possible to suppress the transmission of the excessive torque to the first generator 31 even when the continuous excessive torque is input to the first generator 31. It is possible to suppress mechanical stress from being applied to the first generator 31.

A clutch unit 53 is provided on the second output shaft 22. The clutch unit 53 is a mechanism that transmits or shuts off the drive torque output from the speed increaser 20 to the second generator 32. Various mechanisms may be used for the clutch unit 53. Examples of the mechanism of the clutch unit 53 include a centrifugal clutch and a hydraulic clutch. Since the structure of the clutch unit 53 is known, a description thereof will be omitted.

The clutch control unit 40 is a portion that controls connection and disconnection of the clutch unit 53. Wind speed data measured by the anemometer 3 is input to the clutch control unit 40. When the wind speed indicated by the wind speed data is smaller than the first wind speed value WS1, the clutch control unit 40 disconnects the clutch unit 53. When the wind speed indicated by the wind speed data is larger than the second wind speed value WS2, the clutch control unit 40 connects the clutch unit 53. In the present embodiment, the second wind speed value WS2 is a value larger than the first wind speed value WS1. The first wind speed value WS1 and the second wind speed value WS2 can be appropriately determined in advance according to the wind condition of the area where the wind power generation device 1 is disposed, or the like. For example, the second wind speed value WS2 may be set to 5 [m/s] and the first wind speed value WS1 may be set to 3 [m/s].

The first generator 31 and the second generator 32 are mechanisms that generate electric power using the power distributed by the speed increaser 20. Since the structures of the first generator 31 and the second generator 32 are known, the description thereof will be omitted. The starting torque of the second generator 32 is larger than the starting torque of the first generator 31. The starting torque is the initial torque that needs to be generated by the blade 10 in order to initiate rotation of the generator. In wind power generation, a high torque is required at the start of rotation of the generator. Once the generator starts rotating, the inertial force acts, so that the torque required to maintain the rotating state is less than the starting torque. The starting torque is determined by the resistance of the speed increaser 20, the rotational resistance of the first generator 31 and the second generator 32, the speed transmission ratio of the speed increaser 20, and the like. In the present embodiment, the speed transmission ratio of the first output shaft 21 is larger than that of the second output shaft 22. That is, the first output shaft 21 can output a higher torque than the second output shaft 22. Therefore, the starting torque of the second generator 32 is larger than that of the first generator 31.

Specific Example of the Control of the Wind Power Generation Device 1

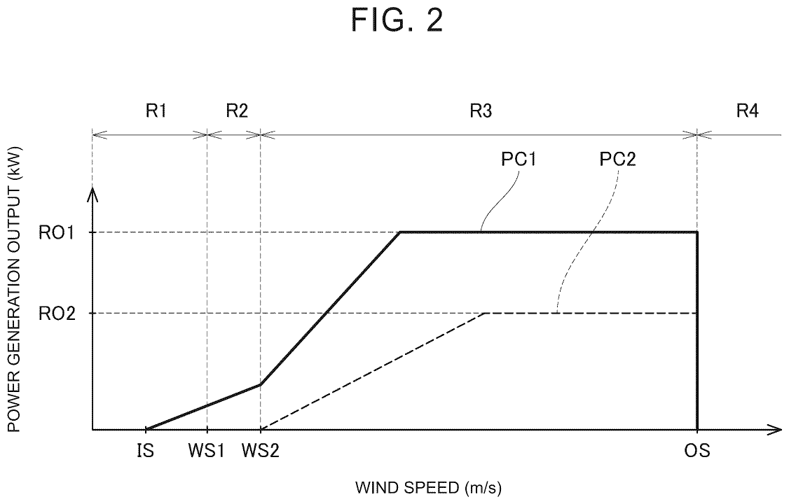

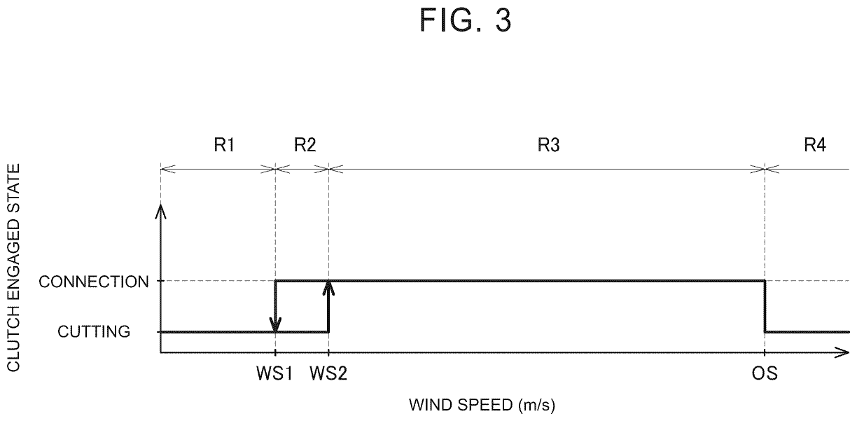

FIG. 2 shows an example of a power curve of the wind power generation device 1. The solid line represents the power curve PC1 of the wind power generation device 1 (FIG. 1) of the present embodiment. The dotted line represents the power curve PC2 of the wind power generation device (not shown) of the comparative embodiment. The wind power generation device of the comparative example is a device using only the second generator 32. FIG. 3 shows an example of clutch engagement control by the clutch control unit 40.

In the area R1 in which the wind speed is smaller than the first wind speed value WS1, the clutch control unit 40 disconnects the clutch unit 53. Therefore, the driving torque of the blade 10 is transmitted only to the first generator 31.

A region where the wind speed is larger than the first wind speed value WS1 and smaller than the second wind speed value WS2 is the hysteresis region R2. In the hysteresis-region R2, the clutch control unit 40 causes the clutch unit 53 to be either connected or disconnected. When the second wind speed value WS2 is reached from a state where the wind speed is smaller than the second wind speed value WS2 in a state where the clutch unit 53 is disconnected, the clutch control unit 40 connects the clutch unit 53 (arrow A1 in FIG. 3). On the other hand, when the first wind speed value WS1 is reached in a direction in which the wind speed decreases from a state in which the wind speed is larger than the first wind speed value WS1 in a state in which the clutch unit 53 is connected, the clutch control unit 40 disconnects the clutch unit 53 (arrow A2 in FIG. 3).

In the area R3 in which the wind speed is larger than the second wind speed value WS2 and smaller than the cut-out wind speed OS, the clutch control unit 40 connects the clutch unit 53. Therefore, the driving torque of the blade 10 is transmitted to both the first generator 31 and the second generator 32. In the area R4 in which the wind speed is larger than the cutout wind speed OS, the clutch control unit 40 disconnects the clutch unit 53.

Effect

When the wind speed is smaller than the first wind speed value WS1 (area R1), it is possible to generate electricity using only the first generator 31. Since the starting torque of the first generator 31 is smaller than that of the second generator 32, the cut-in wind speed IS can be shifted to a lower wind speed. It is possible to increase the power generation amount.

If the wind speed is greater than the second wind speed value WS2 (area R3), both the first generator and the second generator can be used to generate electricity. As compared with the rated output RO2 (FIG. 2) of the comparative wind power generation device using only the second generator 32, the rated output RO1 of the wind power generation device 1 of the present embodiment can be increased. It is possible to increase the power generation efficiency.

In the hysteresis-region R2, the connecting condition of the clutch unit 53 can be controlled depending on the past wind speed. Accordingly, it is possible to prevent undesired transition of the connection state of the clutch unit 53 due to minute fluctuation of the wind speed. It is possible to suppress the occurrence of a hunting phenomenon in which the rotational speed of the second generator 32 fluctuates.

When the wind speed is larger than the cut-out wind speed OS (area R4), the clutch unit 53 can be disconnected. Since the input of the excessive torque to the second generator 32 can be prevented, the failure of the second generator 32 can be prevented. In the first generator 31, since the input of the excessive torque can be prevented by the torque limiter 52, it is possible to prevent a failure.

In the wind power generation device 1 of the present embodiment, the first generator 31 and the second generator 32 can be arranged in parallel to the blade 10 by the speed increaser 20. The axial length of the nacelle 2 (the length in the x-direction in FIG. 1) can be made smaller than the configuration in which the first generator 31 and the second generator 32 are connected in series to the common shaft. It is possible to reduce the overall length of the nacelle 2.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

### Modified Examples

The first output shaft 21 may include a damper. The damper may be provided in place of the torque limiter 52 or in conjunction with the torque limits 52. The damper is a portion that generates torsional elasticity with respect to the torsional force input to the first output shaft 21. Even when the input load fluctuation due to the unstable wind speed fluctuation is input to the first output shaft 21, the damper is torsionally elastically deformed, so that the impact torque input to the first generator 31 can be relaxed. Since it is possible to prevent a large mechanical stress from acting on the first generator 31, it is possible to avoid a failure of the first generator 31. It is possible to improve the maintainability of the wind power generation device 1.

Although a case in which two of the first generator 31 and the second generator 32 are provided has been described, the present disclosure is not limited to this configuration, and three or more generators may be provided. Each of the generators may include a clutch unit, and the wind speed values connecting the clutch units may be different from each other. As a result, the number of generators connected to the blade 10 can be increased one by one as the wind power input to the blade 10 increases. It is possible to further increase the power generation efficiency.

The parameter used for the engagement control of the clutch unit 53 by the clutch control unit 40 is not limited to the wind speed. The engagement control may be performed based on the number of revolutions of the blade 10 and the amount of power generated by the generator.

The technology of the present specification can be applied to any device as long as it is a power generation device including a rotation mechanism. In the present embodiment, the case where the prime mover is the blade 10 for wind power has been described, but the present disclosure is not limited to this configuration. The types of prime movers may vary, such as hydraulic turbines, geothermal turbines, and the like.

The speed increaser 20 is an example of a power distribution unit.

What is claimed is:

1. A wind power generation device comprising:
a blade;
a power distribution unit for distributing power output from the blade;
a first generator to which the power distributed by the power distribution unit is input;
a second generator of which starting torque is larger than starting torque of the first generator and to which the power distributed by the power distribution unit is input;
a clutch unit provided on a power transmission path between the power distribution unit and the second generator; and
a control unit configured to control connection and disconnection of the clutch unit so as to disconnect the clutch unit when a wind speed input to the blade is smaller than a predetermined first wind speed value and connect the clutch unit when the wind speed input to the blade is larger than a predetermined second wind speed value.

2. The wind power generation device according to claim 1, wherein the second wind speed value is larger than the first wind speed value.

3. The wind power generation device according to claim 1, further comprising:
an input shaft for connecting the blade and the power distribution unit;
a first output shaft for connecting the power distribution unit and the first generator; and
a second output shaft for connecting the power distribution unit and the second generator, wherein the number of rotations of the first output shaft per rotation of the input shaft is less than the number of rotations of the second output shaft per rotation of the input shaft.

4. The wind power generation device according to claim 3, further comprising a damper that is provided on the first output shaft and that has torsional elasticity against a torsional force input to the first output shaft.

5. The wind power generation device according to claim 3, further comprising a torque limiter that is provided on the first output shaft and that maintains transmission torque of the first output shaft within upper limit torque.

6. The wind power generation device according to claim 3, further comprising a flywheel provided on the first output shaft.
